(19) United States
(12) Patent Application Publication
(10) Pub. No.: US 2009/0073220 A1
(43) Pub. Date: Mar. 19, 2009

(54) BIDIRECTIONAL PRINTHEAD MAINTENANCE SYSTEMS, METHODS AND APPARATUS

(76) Inventors: Bruce David Gibson, Lexington, KY (US); Amber Catherine Miller, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/856,742

(22) Filed: Sep. 18, 2007

(51) Int. Cl. B41J 2/165

(52) U.S. Cl. 347/33

(57) ABSTRACT

Embodiments of the invention can provide systems, methods, and apparatus for bidirectional printhead maintenance. One embodiment of the invention can provide a method for providing maintenance to a printhead comprising one or more ink nozzles for dispensing ink. The method can include providing a wiper for a printhead, wherein the wiper can include at least a first edge and a second edge. In addition, the method can include manipulating the first edge of the wiper in a forward or rearward direction across some or all of the ink nozzles during printing, wherein at least a portion of the nozzles can be cleaned by the first edge. Furthermore, the method can include manipulating the second edge of the wiper in a forward or rearward direction across some or all of the ink nozzles based at least in part on a maintenance-type command, wherein at least a portion of the nozzles can be cleaned by the second edge.

### FIELD OF THE INVENTION

The invention relates generally to ink jet printers, and more particularly, to bidirectional printhead maintenance systems, methods, and apparatus.

### BACKGROUND OF THE INVENTION

One problem with conventional ink jet printers and printheads is the ability of the printers to maintain the respective printheads. Through an inkjet print process, ink can be accumulated on a nozzle plate of the printhead. Wet ink on the nozzle plate, and around the respective nozzle openings, can result in misdirection of an ink drop, causing it to land “off-target” on a page being printed by the printer. Additionally, dry ink on the nozzle plate can clog one or more nozzle openings and prevent the nozzle from jetting altogether.

In some instances, an ink jet printer can include a maintenance station that performs maintenance-type routines or operations to preserve the life of an associated printhead. For example, a maintenance station for an ink jet printer can include a printhead wiper. A printhead wiper is typically an elongated rubber device having a relatively sharp edge for wiping residual ink from one or more nozzles of the nozzle plate. A maintenance wiping routine or operation utilizing the printhead wiper can prevent one or more of the nozzles from becoming blocked with contaminants, such as dried ink and accumulated paper dust, thereby extending the life of the printhead.

Other maintenance routines or operations can be utilized to prevent accumulation of ink on a printhead. For example, one maintenance routine can involve cleaning a nozzle plate with a printhead wiper at pre-determined intervals, such as at the start of every print job and after a certain number of fires or dispensing a certain amount of ink. In another example, a maintenance routine can involve prompting a customer to print a “clean page”, which is designed to recover one or more clogged nozzles. Yet another example maintenance routine can involve a “wet wipe” or manual removal of a printhead from the ink jet printer, wherein the nozzle plate is wiped with a clean, wet cloth, and the printhead is reinstalled in the printer.

However, conventional ink jet printers with maintenance stations utilizing conventional maintenance routines or operations can still encounter print quality problems due to missing or misdirected nozzles. Furthermore, use of conventional maintenance routines with relatively newer, semi-permanent printheads can encounter similar print quality problems.

Therefore, a need exists for bidirectional printhead maintenance systems, methods, and apparatus.

A further need exists for providing maintenance to a printhead comprising one or more ink nozzles for dispensing ink

### SUMMARY OF THE INVENTION

Some or all of the above needs can be addressed by some or all of the embodiments described herein. Embodiments of the invention can provide bidirectional printhead maintenance systems, methods, and apparatus. Other embodiments of the invention can provide maintenance to a printhead comprising one or more ink nozzles for dispensing ink. According to one embodiment of the invention, a method for providing maintenance to a printhead comprising one or more ink nozzles for dispensing ink can be provided. The method can include providing a wiper for a printhead, wherein the wiper can include at least a first edge and a second edge. In addition, the method can include manipulating the first edge of the wiper in a forward or rearward direction across some or all of the ink nozzles during printing, wherein at least a portion of the nozzles can be cleaned by the first edge. Furthermore, the method can include manipulating the second edge of the wiper in a forward or rearward direction across some or all of the ink nozzles based at least in part on a maintenance-type command, wherein at least a portion of the nozzles can be cleaned by the second edge.

In one aspect of this embodiment, the maintenance-type command is received from at least one of the following: a user, a printer, a server, a processor, a memory, a data storage device, a client-type device, or a remote location.

In another aspect of this embodiment, some or all of the ink nozzles are mounted to a nozzle plate associated with the printhead.

Another embodiment of the invention can provide a system for providing maintenance to a printhead comprising one or more ink nozzles for dispensing ink. The system can include at least one wiper, which can include at least a first edge operable to be manipulated in a forward or rearward direction across some or all of the ink nozzles, wherein at least a portion of the nozzles can be cleaned by the first edge. The wiper can also include at least a second edge operable to be manipulated in a forward or rearward direction across some or all of the ink nozzles based at least in part on a maintenance-type command, wherein at least a portion of the nozzles can be cleaned by the second edge. Furthermore, the system can include a drive mechanism operable to control the at least one wiper.

In one aspect of this embodiment, the maintenance-type command is received from at least one of the following: a user, a printer, a server, a processor, a memory, a data storage device, a client-type device, or a remote location.

Another embodiment of the invention can provide a method for providing maintenance to a printhead comprising one or more ink nozzles for dispensing ink. The method can include providing a wiper for a printhead, wherein the wiper can include at least a first edge and a second edge. In addition, the method can provide manipulating the first edge of the wiper in a first direction across some or all of the ink nozzles during at least a portion of a first time period, wherein at least a portion of the nozzles can be cleaned by the leading edge. Furthermore, the method can provide manipulating the second edge of the wiper in a second direction across some or all of the ink nozzles during at least a portion of a second time period, wherein at least a portion of the nozzles can be cleaned by the second edge.

One aspect of this embodiment can include manipulating the first edge of the wiper in the first direction across some or all of the ink nozzles of a new printhead after the printhead is replaced with a new printhead, and manipulating the second edge of the wiper in the second direction across some or all of the ink nozzles of the new printhead.

In another aspect of this embodiment, the first time period can include at least one of the following: a half life of the printhead, a half life of a printer associated with the printhead, a half life of at least one component of the printhead, a half life of at least one component associated with a printer associated with the printhead, an event associated with a printhead, an event associated with a printer, a number of pages printed, a number of ink drops fired or dispensed, or a number of times a printhead or printhead wiper has moved in at least one predefined direction.

In another aspect of this embodiment, the first time period can include a first half life for the printhead, and the second time period can include a second half life.

In another aspect of this embodiment, the first time period can include a first half life for a printer associated with the printhead, and the second time period can include a second half life for the printer associated with the printhead.

In another aspect of this embodiment, the time period is determined by at least one of the following: a user, a printer, a server, a processor, a memory, a data storage device, or a client-type device.

In another aspect of this embodiment, manipulating the first edge of the wiper in a first direction can include either manipulating the first edge of the wiper in a forward or rearward direction, or moving the printhead in a forward or rearward direction across a relatively stationary printhead wiper.

In another aspect of this embodiment, manipulating the second edge of the wiper in a second direction can include either manipulating the second edge of the wiper in forward or rearward direction, or moving the printhead in a forward or rearward direction across a relatively stationary printhead wiper.

In another aspect of this embodiment, some or all of the ink nozzles can be mounted to a nozzle plate associated with the printhead.

One embodiment of the invention can provide a system for providing maintenance to a printhead comprising one or more ink nozzles for dispensing ink. The system can include at least one wiper, which can include at least a first edge operable to be manipulated in a first direction across some or all of the ink nozzles during at least a portion of a first time period, wherein at least a portion of the nozzles can be cleaned by the leading edge. Moreover, the wiper can include at least a second edge operable to be manipulated in a second direction across some or all of the ink nozzles during at least a portion of a second time period, wherein at least a portion of the nozzles can be cleaned by the second edge. In addition, the system can include a drive mechanism operable to control the at least one wiper.

In one aspect of this embodiment, the first time period can include at least one of the following: a half life of the printhead, a half life of a printer associated with the printhead, a half life of at least one component of the printhead, a half life of at least one component associated with a printer associated with the printhead, an event associated with a printhead, an event associated with a printer, a number of pages printed, a number of ink drops fired or dispensed, or a number of times a printhead or printhead wiper has moved in at least one predefined direction.

In another aspect of this embodiment, the first time period can include a first half life for the printhead, and the second time period can include a second half life.

In another aspect of this embodiment, the first time period can include a first half life for a printer associated with the printhead, and the second time period can include a second half life for the printer associated with the printhead.

In another aspect of this embodiment, the first time period or the second time period is determined by at least one of the following: a user, a printer, a server, a processor, a memory, a data storage device, or a client-type device.

In another aspect of this embodiment, the first direction or the second direction can include a forward or rearward direction.

Another embodiment of the invention can provide a method for providing maintenance to a printhead comprising one or more ink nozzles for dispensing ink. The method can include providing a wiper, which can include at least a first edge operable to wick at least a portion of ink from some or all of the ink nozzles when the first edge is manipulated in one direction across some or all of the ink nozzles. The wiper can also include at least a second edge operable to be manipulated in another direction across some or all of the ink nozzles, wherein at least a portion of the nozzles can be cleaned by the second edge. Furthermore, the method can include manipulating the first edge of the wiper to wick at least a portion of ink from some or all of the ink nozzles. In addition, the method can include manipulating the second edge of the wiper to clean ink from some or all of the ink nozzles.

In one aspect of this embodiment, the first edge can include a relatively rounded surface.

In another aspect of this embodiment, the second edge can include a relatively sharp surface.

In another aspect of this embodiment, the wiper can be manipulated in a forward or rearward direction.

Another embodiment of the invention can provide an apparatus for providing maintenance to a printhead comprising one or more ink nozzles for dispensing ink. The apparatus can include at least one wiper, which can include a first edge operable to wick at least a portion of ink from some or all of the ink nozzles when the first edge is manipulated in one direction across some or all of the ink nozzles. The at least one wiper can also include a second edge operable to be manipulated in another direction across some or all of the ink nozzles, wherein at least a portion of the nozzles can be cleaned by the second edge.

In one aspect of this embodiment, the apparatus can also include a drive mechanism associated with a printer, wherein the at least one wiper can mount to at least a portion of the drive mechanism, and the drive mechanism is operable to control the at least one wiper.

In one aspect of this embodiment, the first edge can include a relatively rounded surface.

In another aspect of this embodiment, the second edge can include a relatively sharp surface.

In another aspect of this embodiment, the at least one wiper can be manipulated in a forward or rearward direction.

Yet another embodiment of the invention can provide an imaging system with a printhead comprising one or more ink nozzles. The imaging system can include at least one wiper, which can include a first edge operable to wick at least a portion of ink from some or all of the ink nozzles when the first edge is manipulated in a forward or rearward direction across some or all of the ink nozzles. The at least one wiper can also include a second edge operable to be manipulated in a forward or rearward direction across some or all of the ink nozzles, wherein some or all of the nozzles can be cleaned by the second edge. In addition, the imaging system can include a drive mechanism operable to control the at least one wiper.

In one aspect of this embodiment, first edge can include a relatively rounded surface.

In another aspect of this embodiment, second edge can include a relatively sharp surface.

In another aspect of this embodiment, the imaging system can include a processor operable to control the drive mechanism and at least one wiper.

In another aspect of this embodiment, the at least one wiper can include a plurality of wipers.

Other systems, processes, and apparatus according to various embodiments of the invention will become apparent with respect to the remainder of this document.

### BRIEF DESCRIPTION OF THE DRAWINGS

Having thus described the invention in general terms, reference will now be made to the accompanying drawings, which are not necessarily drawn to scale, and wherein:

FIG. 1 is a representation of an example imaging system employing an embodiment of the invention.

FIG. 2 is an enlarged side view of a printhead wiper for providing maintenance to a printhead in accordance with one embodiment of the invention.

FIG. 3 is an enlarged perspective view of the printhead wiper shown in FIG. 2.

FIG. 4 is a schematic side view of a printhead wiper for providing maintenance to a printhead in accordance with one embodiment of the invention.

FIG. 5 is an example configuration for a printhead wiper for providing maintenance to a printhead in accordance with one embodiment of the invention.

FIG. 6 is an example method for providing maintenance to a printhead in accordance with an embodiment of the invention.

FIG. 7 is another example method for providing maintenance to a printhead in accordance with an embodiment of the invention.

FIG. 8 is another example method for providing maintenance to a printhead in accordance with an embodiment of the invention.

### DETAILED DESCRIPTION OF EMBODIMENTS OF THE INVENTION

Embodiments of the invention now will be described more fully hereinafter with reference to the accompanying drawings. Indeed, these inventions may be embodied in many different forms and should not be construed as limited to the embodiments set forth herein; rather, these embodiments are provided so that this disclosure will satisfy applicable legal requirements. Like numbers refer to like elements throughout.

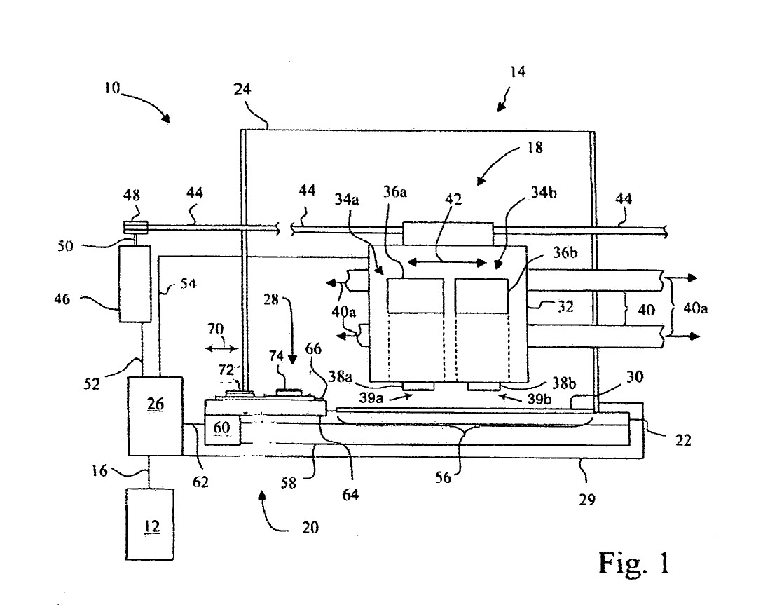

Referring now to the drawings, and particularly to FIG. 1, there is shown an imaging system 10 embodying an embodiment of the invention. In one embodiment, the imaging system 10 can utilize a system and apparatus including a printhead wiper for maintaining a printhead associated with the imaging system. In another embodiment, the imaging system 10 can utilize one or more maintenance routines, operations, or processes for maintaining a printhead associated with the imaging system.

As shown in FIG. 1, imaging system 10 may include a host 12, or alternatively, imaging system 10 may be a standalone system. Imaging system 10 can include an imaging apparatus 14, which may be in the form of an ink jet printer, as shown. Thus, for example, imaging apparatus 14 may be a conventional ink jet printer, or may form the print engine for a multi-function apparatus, such as for example, a standalone unit that has faxing and copying capability, in addition to printing.

Host 12, which may be optional, may be communicatively coupled to imaging apparatus 14 via at least one communications link 16. As used herein, the term “communications link” is used to generally refer to structure that facilitates electronic or radio frequency communication between two components, and may operate using wired or wireless technology. Thus, communications link 16 may be, for example, a direct electrical connection, radio frequency connection, a wireless connection, or a network connection.

In the embodiment shown, host 12 may be, for example, a client-type device or personal computer including a display device, an input device (e.g., keyboard), a processor, input/output (I/O) interfaces, memory, such as RAM, ROM, NVRAM, and a mass data storage device, such as a hard drive, CD-ROM and/or DVD units. During operation, host 12 can include in its memory a software program including program instructions or a set of computer-executable instructions that can function as a printer driver for an imaging apparatus, such as 14. The printer driver can be in communication with imaging apparatus 14 via at least one communications link, such as 16. The printer driver, for example, can include a halftoning unit and a data formatter that places print data and print commands in a format that can be recognized by imaging apparatus 14.

In one embodiment, a printer driver may include a set of instructions to provide control signals to imaging apparatus 14, and in particular, to associated ink jetting actuators of ink jet printheads 38a, 38b, or alternatively, to a maintenance station 28, to effect one or more maintenance-type commands received from at least one of the following: a user, a printer, a server, a processor, a memory, a data storage device, a client-type device, or a remote location. A maintenance-type command can include, but is not limited to, an instruction to wipe a printhead with a printhead wiper, an instruction to print a clean page, an instruction to manipulate a printhead wiper in a forward or rearward direction, an instruction to manipulate a printhead wiper with respect to a printhead, an instruction to manipulate a printhead with respect to a printhead wiper, and instruction to manipulate both a printhead wiper and printhead in coordination with each other. In a network environment, communications between host 12 and imaging apparatus 14 may be facilitated via a standard communication protocol, such as the Network Printer Alliance Protocol (NPAP).

In another embodiment, a print driver may include instructions to determine one or more time periods for manipulating a printhead wiper. A time period can include, but is not limited to, an expected half life of the printhead, an expected half life of a printer associated with the printhead, an expected half life of at least one component of the printhead, and an expected half life of at least one component associated with a printer associated with the printhead. In one embodiment, a time period can be based in part on at least one of the following: a user, a printer, a server, a processor, or a client-type device. In another embodiment, a time period can be based in part on at least an event associated with a printhead, an event associated with a printer a number of pages printed, a number of ink drops fired or dispensed, or a number of times a printhead or printhead wiper moves in at least one predefined direction.

In other embodiments, a host can be a server, or a client-type device associated with at least one of the following: a user, a printer, a server, a processor, a memory, a data storage device, a client-type device, or a remote location. In some or all of these embodiments, a host can include in its memory a software program including program instructions or a set of computer-executable instructions that can function as a printer driver for an imaging apparatus, such as 14, which may include a set of instructions for providing one or more maintenance-type commands.

In one embodiment, one or more maintenance-type commands can be provided by a client-type device operated in a remote location, such as a customer service center. The maintenance-type commands can be transmitted via a network to the communications link 16 and to the imaging apparatus 14. In this particular embodiment, the maintenance-type commands could be implemented, and certain activities, such as manipulating a printhead wiper, can be facilitated.

Imaging apparatus 14, in the form of an ink jet printer, can include a printhead carrier system 18, a feed roller unit 20, a mid-frame 22, a media source 24, a controller 26 and a maintenance station 28. Printhead carrier system 18, feed roller unit 20, mid-frame 22, media source 24, controller 26 and maintenance station 28 may be mounted to an imaging apparatus frame 29.

Media source 24 can be configured and arranged to supply from a stack of print media a sheet of print media 30 to feed roller unit 20, which in turn further transports the sheet of print media 30 during a printing operation.

Printhead carrier system 18 can include a printhead carrier 32 that carries, for example, one or more printhead cartridges, such as a monochrome printhead cartridge 34a and/or a color printhead cartridge 34b, which may be removably or permanently attached thereto. Monochrome printhead cartridge 34a can include a monochrome ink reservoir 36a provided in fluid communication with a monochrome ink jet printhead 38a. Color printhead cartridge 34b can include a color ink reservoir 36b provided in fluid communication with a color ink jet printhead 38b. Alternatively, ink reservoirs 36a, 36b may be located off-carrier, and coupled to respective ink jet printheads 38a, 38b via respective fluid conduits. Also, alternatively, monochrome printhead cartridge 34a may be replaced with another color printhead cartridge, such as for example, a photo printhead cartridge. In any instance, each of the printheads such as 38a, 38b can include one or more nozzle plates and ink jet nozzles 39a, 39b, from which ink can be dispensed from the respective printhead such as 38a, 38b.

Printhead carrier 32 can be guided by a pair of guide members 40. Either, or both, of guide members 40 may be, for example, a guide rod, or a guide tab formed integral with imaging apparatus frame 29. The axes 40a of guide members 40 can define a bidirectional scanning or printing path 42 of printhead carrier 32. Printhead carrier 32 can be connected to a carrier transport belt 44 that can be driven by a carrier motor 46 via a carrier pulley 48. In this manner, carrier motor 46 can be drivably coupled to printhead carrier 32, although one skilled in the art will recognize that other drive coupling arrangements could be substituted for the example given, such as for example, a worm gear drive. Carrier motor 46 can be, for example, a direct current motor or a stepper motor. Carrier motor 46 can have a rotating motor shaft 50 that is attached to carrier pulley 48. Carrier motor 46 can be coupled to controller 26 via a communications link 52. At a directive of controller 26, printhead carrier 32 can be transported in a controlled manner along bidirectional scanning path 42, via the rotation of carrier pulley 48 imparted by carrier motor 46.

Ink jet printheads 38a, 38b can be electrically connected to controller 26 via at least one communications link 54. Controller 26 can supply electrical address and control signals to imaging apparatus 14, and in particular, to associated ink jetting actuators of ink jet printheads 38a, 38b, to effect the selective ejection of ink from ink jet printheads 38a, 38b. Furthermore, controller 26 can supply electrical address and control signals to imaging apparatus 14, and in particular, to associated ink jetting actuators of ink jet printheads 38a, 38b, or alternatively, to a maintenance station 28, to effect one or more maintenance-type commands received from at least one of the following: a user, a printer, a server, a processor, a memory, a data storage device, a client-type device, or a remote location.

During a printing operation, printhead carrier 32 can transport ink jet printheads 38a, 38b across the sheet of print media 30 in a reciprocating manner along bi-directional scanning path 42, i.e., a scanning direction, to define a print zone 56 of imaging apparatus 14. Bi-directional scanning path 42, which is parallel with axes 40a of guide members 40, also may be referred to as main scan path 42 of printhead carrier 32. The sheet of print media 30 can be transported in an incremental fashion through print zone 56 by the rotation of a feed roller 58 of feed roller unit 20. The rotation of feed roller 58 can be effected by a drive unit 60. Drive unit 60 can be electrically connected to controller 26 via at least one communications link 62.

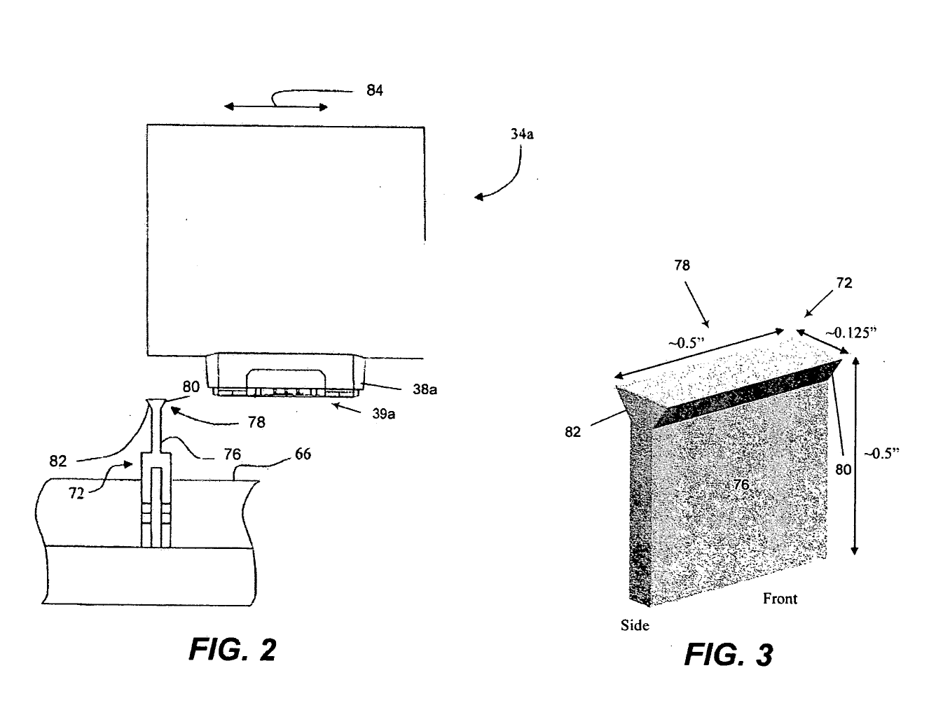

Maintenance station 28 is provided for performing various printhead maintenance operations on some or all of the ink jet nozzles 39a, 39b of ink jet printheads 38a, 38b. Such operations may include, for example, a printhead wiping operation. Examples of printhead wiping operations are described below in FIGS. 2-8. Other services in other embodiments, can include for example, printhead spit maintenance operation, a printhead maintenance capping operation, and printhead priming and suction. In order to conduct printhead maintenance operations, such as a printhead wiping operation, controller 26 can control the movement of printhead carrier 32 to position printhead carrier 32 in relation to maintenance station 28, or alternatively, the movement of maintenance station 28 to position maintenance station 28 in relation to printhead carrier 32.

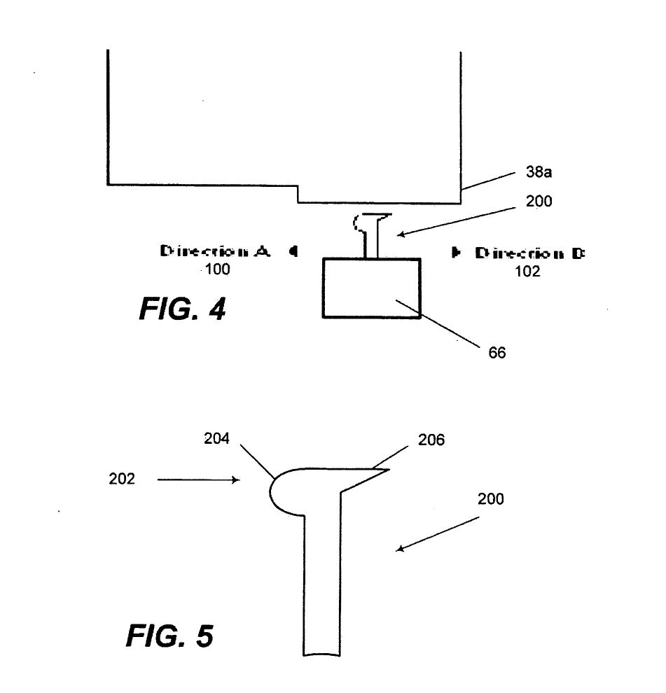

Maintenance station 28 can include a maintenance housing 64, a movable maintenance sled 66. Maintenance housing 64 can support movable maintenance sled 66. In the embodiment shown, maintenance sled 66 can be configured for movement in the leftward and rightward directions, generally shown as 70, and/or in the forward and rearward directions, 100 and 102, generally shown in FIG. 4. In some embodiments, the directions generally depicted as 100, 102 in FIG. 4, and by double-headed arrow 70 in FIG. 1 can include both horizontal and vertical components. Mounted to maintenance sled 66 can be one or more printhead wipers 72, 74. In the embodiment shown in FIG. 1, printhead wiper 72 can interact with printhead 38a, and printhead wiper 74 can interact with printhead 38b.

Maintenance sled 66 can be manipulated by the system 10 to move with respect to the printheads 38a, 38b. For example, a drive unit, such as 60 or another independent drive mechanism, can cause printhead carrier 32 to engage a portion of the maintenance sled 66, thereby facilitating contact by one or both of the printhead wipers 72, 74 with the respective printheads 38a, 38b. Following the wiping of printheads 38a, 38b, the drive unit, such as 60 or another independent drive mechanism, can manipulate the maintenance sled 66 to disengage contact and either or both of the printhead wipers 72, 74 can be disengaged from the respective printheads 38a, 38b. In the embodiment shown in FIG. 1, movement of the printhead wipers 72, 74 with respect to the printheads 38a, 38b can be in either or both of the directions perpendicular (into and away from the page) to the arrows 70. In one embodiment, movement of the printhead wipers 72, 74 with respect to the printheads 38a, 38b can be in either or both of the directions shown by the arrows 70.

In one embodiment, a maintenance station, such as 28, can include a maintenance housing and a relatively stationary maintenance sled. In this embodiment, the stationary maintenance sled can include one or more printhead wipers, similar to 72 shown in FIGS. 1-4, which remain relatively stationary as one or more printheads, similar to 38a, 38b, are moved across the wiper. For example, a printhead can be manipulated with either a forward to rearward, or a left to right movement across a relatively stationary printhead wiper to achieve the maintenance interaction between the printhead and printhead wipers as described in other embodiments herein.

The system 10 shown in FIG. 1 is by way of example, and other system embodiments can include some or all of the above components.

FIG. 2 shows a detail front view of the printhead cartridge 34a and a portion of maintenance sled 66 of FIG. 1, with maintenance sled 66 in proximity to an example printhead wiper 72 prior to performing a printhead wiping function with respect to printhead 38a. FIG. 3 shows an enlarged perspective view of the example printhead wiper 72 shown in FIG. 2. As shown in FIGS. 2 and 3, a printhead wiper, such as 72, can include an elongate body 76 and wiper head 78 attached to elongate body 76. Printhead wiper 72 may be formed as an integral device made from an elastomeric material, such as rubber. Wiper head 78 can include a wiping edge, such as first edge 80, and a second wiping edge, such as second edge 82 adjacent first edge 80. While wiper 72 and printhead cartridge 34a are used for purposes of this example, it is to be understood that the principles of various embodiments of the invention that are described with respect to wiper 72 and printhead cartridge 34a would also apply to wiper 74 and printhead cartridge 34b. The shape and configuration of the printhead wipers 72, 74 shown in FIGS. 1, 2, and 3 are by way of example, and other shapes and configurations can exist in accordance with embodiments of the invention, such as the printhead wiper 200 shown in FIGS. 4 and 5.

Optionally, each of printhead cartridges 34a, 34b can include a printhead wiper cleaning mechanism. Examples of printhead wiper cleaning mechanisms are described in U.S. Ser. No. 10/944,013, filed on Sep. 16, 2004, and published in U.S. Publication No. US 2006/0055729 A1 on Mar. 16, 2006.

In the embodiment shown in FIG. 2, movement of the printhead wiper 72 with respect to the printhead 38a can be in either or both of the directions (left and right) shown by the arrows 84. In one embodiment, movement of the printhead wiper 72 with respect to the printhead 38a can be either or both of the directions perpendicular (into and away from the page) to the arrows 84. That is, in either or both a forward or rearward direction as shown and described in FIG. 1.

FIG. 4 illustrates a side view and associated movement of the maintenance sled and associated wiper shown in FIG. 1. As shown in FIG. 4, the maintenance sled 66 and associated wiper 200 can be moved in either a forward direction (direction A) 100 or a rearward direction (direction B) 102, or both, by a controller, such as 26 described in FIG. 1. In some instances, the forward direction 100 can be referred to as the north direction, or towards a front surface of a printer, and the rearward direction 102 can referred to as the south direction, or towards a rear or back surface of the printer. In the embodiment shown in FIG. 4, the printhead wiper 200 can interact with a printhead, such as 38a, to facilitate a maintenance wiping routine or operation.

In one embodiment, movement of a printhead wiper, such as 72 or 200, with respect to a printhead, such as 38a, can be in any combination of directions including, but not limited to, leftward, rightward, forward, and rearward. A drive unit or mechanism, similar to 60 in FIG. 1, can be implemented and controlled by a controller, similar to 26 in FIG. 1, to move either or both the printhead wiper and/or the printhead to facilitate a wiping routine or operation.

FIG. 5 illustrates an example configuration of an example printhead wiper in accordance with an embodiment of the invention. In this embodiment, a printhead wiper 200 may be formed as an integral device made from an elastomeric material, such as rubber. Wiper head 202 can include a first edge or wicking edge 204, and a second edge or wiper surface 206 adjacent to the first edge or wicking edge 204. The wicking edge 204 can be, for example, a relatively rounded surface or edge adjacent to another or opposing side of the wiper head 202. The relatively rounded surface or edge can facilitate wicking relatively wet ink from one or more of the nozzles onto the nozzle plate and adjacent to one or more nozzles. The wiping edge 206 can be, for example, a relatively sharp or crisp edge adjacent to one side of the wiper head 202. The relatively sharp or crisp edge can facilitate cleaning dried ink and other debris which may collect on a nozzle plate or adjacent to one or more nozzles. In other embodiments, other configurations and shapes of a printhead wiper can be used in accordance with the invention.

In one embodiment of a printhead wiper, a wiper head for a printhead wiper can be approximately 0.5 inches (12.8 mm) in width and approximately 0.5 inches (12.8 mm) in height. Furthermore, a first edge and second edge of the printhead wiper can be spaced apart, for example, by approximately 0.125 inches (3.2 mm).

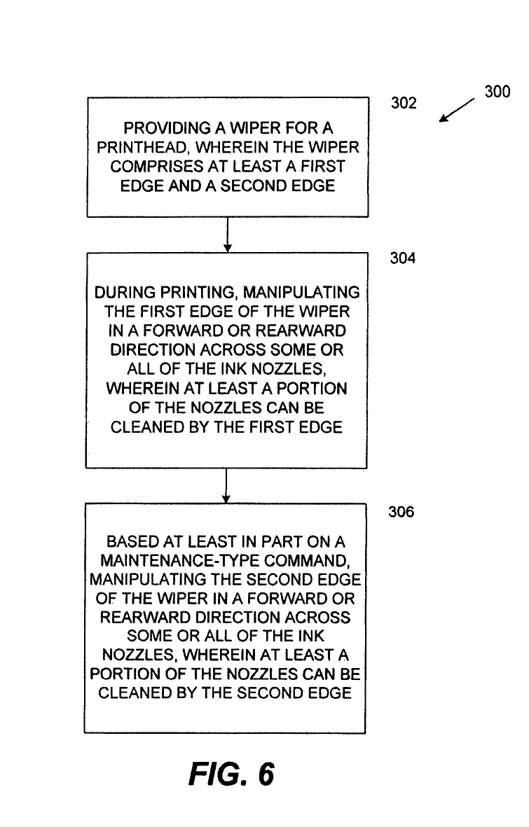

The system 10 described in FIGS. 1-4, and printhead wipers of FIGS. 1-5, can be used to implement some or all of the processes or methods of FIGS. 6-8. Other embodiments of process flows and methods for providing maintenance for a printhead comprising one or more ink nozzles for dispensing ink or bidirectional printhead maintenance can include fewer or greater numbers of steps, and may include some or all of the elements described in FIGS. 6-8. Arrows in each process or method flow are intended to indicate signal and/or data flow from one functional component block to another, and the order of execution of each numbered functional component block is not necessarily consecutively performed, but rather, the numbered functional component blocks are for the convenient reference to the accompanying description below.

FIG. 6 illustrates an example method for providing maintenance for a printhead comprising one or more ink nozzles for dispensing ink. The method 300 begins at block 302. In block 302, a wiper is provided for a printhead, wherein the wiper can include at least a first edge and a second edge. In this embodiment, a printhead, such as 38a in FIG. 1, can include a printhead wiper, such as 72. The printhead wiper 72 can include a first edge, such as 80 in FIG. 2, and a second edge, such as 82, adjacent to the first edge 80. Other embodiments of a wiper can include additional surfaces or edges, and may have different configurations or shapes than the wipers shown in FIGS. 1-5.

Block 302 is followed by block 304, in which during printing, the first edge of the wiper is manipulated in a forward or rearward direction across some or all of the ink nozzles, wherein at least a portion of the nozzles can be cleaned by the first edge. In this embodiment, the first edge, such as 80 in FIG. 2, can be manipulated during a printing process, in a forward or rearward direction by an associated controller, such as 26 in FIG. 1, with respect to one or more nozzles associated with a printhead, such as 38a. The forward and rearward direction can be similar to the directions, 100 and 102 shown in FIG. 4. In this manner, dried ink and other debris can be removed from some or all of the nozzles, and the nozzles can be cleaned by the first edge 80. In one embodiment, some or all of the ink nozzles can be mounted to a nozzle plate associated with the printhead.

Block 304 is followed by block 306, in which based at least in part on a maintenance-type command, the second edge of the wiper is manipulated in a forward or rearward direction across some or all of the ink nozzles, wherein at least a portion of the nozzles can be cleaned by the second edge. In this embodiment, after a maintenance-type command can be received from a controller, such as 26 in FIG. 1, a second edge, such as 82 in FIG. 2, can be manipulated in an opposing forward or rearward direction with respect to one or more nozzles associated with a printhead, such as 38a. The forward and rearward direction can be similar to the directions, 100 and 102 shown in FIG. 4. In this manner, dried ink and other debris can be removed from some or all of the nozzles, and the nozzles can be cleaned by the first edge 80. In one embodiment, the maintenance-type command can be received from at least one of the following: a user, a printer, a server, a processor, a client-type device, or a remote location.

In block 306, the method 300 ends. Other methods for providing maintenance for a printhead comprising one or more ink nozzles for dispensing ink or bidirectional printhead maintenance can include some or all of the above elements as well as other elements in accordance with the invention.

In this manner, the method 300 can provide reserve wiping in at least one direction, such as either forward to rearward (north to south) or rearward to forward (south to north), such that the printhead wipes in this direction occur during an attempt to recover nozzles. All other maintenance and printing would wipe the printhead in the other direction. The methodology of this embodiment can accomplish at least two goals. First, any accumulated ink on the printhead wiper may be minimized because the wiper edge may not have the ink build-up from wipes during printing and maintenance. Second, the wiper edge may be relatively sharper or crisper as it has not been worn down by previous wipes. Furthermore, the methodology of this embodiment can provide a higher likelihood for the associated ink jet printer to successfully recover missing nozzles due to ink on the nozzle plate, thus eliminating or significantly reducing the need to perform a wet wipe of the printhead as well as reducing service center calls.

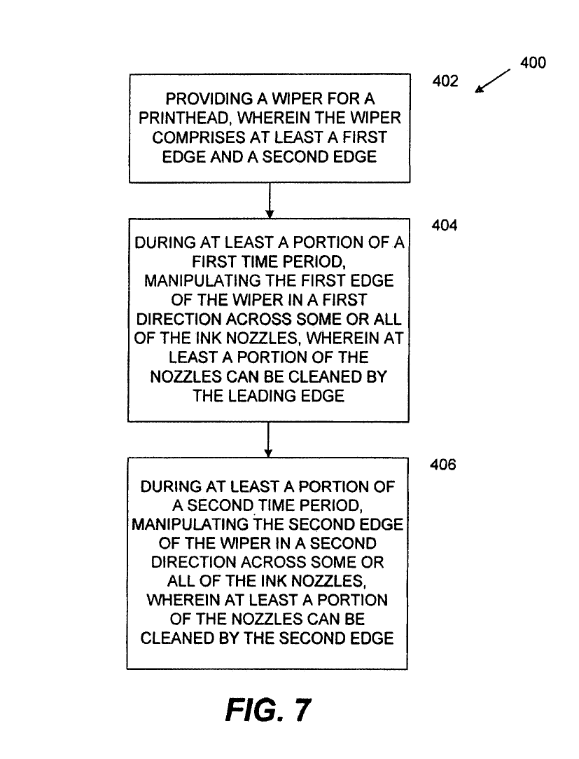

FIG. 7 illustrates an example method for providing maintenance for a printhead comprising one or more ink nozzles for dispensing ink. The method 400 begins at block 402. In block 402, a wiper is provided for a printhead, wherein the wiper can include at least a first edge and a second edge. In this embodiment, a printhead wiper, such as 72 in FIG. 1, can include a first edge, such as 80 in FIG. 2, and a second edge, such as 82.

Block 402 is followed by block 404, in which during at least a portion of a first time period, the first edge of the wiper is manipulated in a first direction across some or all of the ink nozzles, wherein at least a portion of the nozzles can be cleaned by the leading edge. In this embodiment, the first edge, such as 80, can be manipulated during a portion of a first time period by an associated controller, such as 26, with respect to one or more nozzles associated with a printhead, such as 38a. In one embodiment, the first time period can include at least one of the following: a half life of the printhead, a half life of a printer associated with the printhead, a half life of at least one component of the printhead, or a half life of at least one component associated with a printer associated with the printhead. In one embodiment, the time period can be determined by at least one of the following: a user, a printer, a server, a processor, or a client-type device. In one embodiment, manipulating the first edge of the wiper in a first direction can include manipulating the first edge of the wiper in a forward or rearward direction, such as the forward and rearward directions, 100 and 102 shown in FIG. 4.

Block 404 is followed by block 406, in which during at least a portion of a second time period, the second edge of the wiper is manipulated in a second direction across some or all of the ink nozzles, wherein at least a portion of the nozzles can be cleaned by the second edge. In this embodiment, the second edge, such as 82, can be manipulated during a portion of a second time period by an associated controller, such as 26, with respect to one or more nozzles associated with a printhead, such as 38a. In one embodiment, the first time period can include a first half life for the printhead, and the second time period can include a second half life. In another embodiment, the first time period can include a first half life for a printer associated with the printhead, and the second time period can include a second half life for the printer associated with the printhead. In another embodiment, manipulating the second edge of the wiper in a second direction can include manipulating the second edge of the wiper in forward or rearward direction, such as the forward and rearward directions, 100 and 102 shown in FIG. 4. In one embodiment, some or all of the ink nozzles can be mounted to a nozzle plate associated with the printhead.

In one embodiment, after the printhead is replaced with a new printhead, the first edge of the wiper can be manipulated in the first direction across some or all of the ink nozzles of the new printhead, and the second edge of the wiper can be manipulated in the second direction across some or all of the ink nozzles of the new printhead.

In block 406, the method 400 ends. Other methods for providing maintenance for a printhead comprising one or more ink nozzles for dispensing ink or bidirectional printhead maintenance can include some or all of the above elements as well as other elements in accordance with the invention.

In this manner, the method 400 can provide wiping the printhead in one direction for the first half of the printhead life and then reversing the wipe direction for the second half of the printhead life. When a new head is installed, wiping can revert to the “first” direction for the first half of the new printhead's life before switching directions for the second half of the printhead's life, and so on. In one embodiment, directions can be switched on a printer life basis such that the printer would wipe in one direction for the first half of the printer life (based on number of pages) and reverse to wipe in the opposite direction for the second half of the printer life. The methodology of this embodiment can effectively prolong the life of the printhead wiper, and at the same time has the ability to provide cost savings by reducing the relative durability of the printhead wiper and/or minimizing any need to provide two printhead wipers as opposed to one.

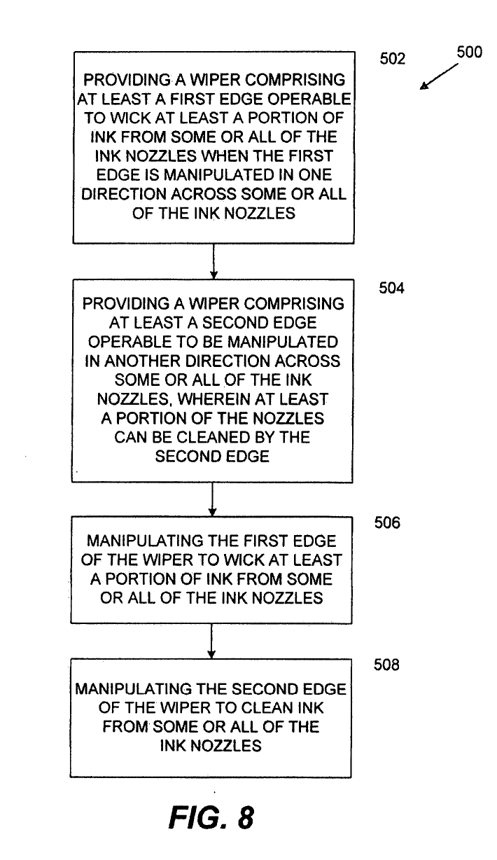

FIG. 8 illustrates an example method for providing maintenance for a printhead comprising one or more ink nozzles for dispensing ink. The method 500 begins at block 502. In block 502, a wiper can be provided. The wiper can include at least a first edge operable to wick at least a portion of ink from some or all of the ink nozzles when the first edge is manipulated in one direction across some or all of the ink nozzles. The wiper can also include at least a second edge operable to be manipulated in another direction across some or all of the ink nozzles, wherein at least a portion of the nozzles can be cleaned by the second edge. In this embodiment, a printhead wiper, such as 200 in FIG. 5, can include a first edge, or wicking edge such as 204, and a second edge, or wiper edge such as 206. In one embodiment, the first edge can include a relatively rounded surface. In another embodiment, the second edge can include a relatively sharp surface. In another embodiment, the wiper can be manipulated in a forward or rearward direction, such as the forward and rearward directions, 100 and 102 shown in FIG. 4.

Block 502 is followed by block 504, in which the first edge of the wiper is manipulated to wick at least a portion of ink from some or all of the ink nozzles. In this embodiment, the first edge, such as rounded edge 204, can be manipulated by an associated controller, such as 26, with respect to one or more nozzles associated with a printhead, such as 38a.

Block 504 is followed by block 506, in which the second edge of the wiper is manipulated to clean ink from some or all of the ink nozzles. In this embodiment, the second edge, such as relatively sharp edge 206, can be manipulated by an associated controller, such as 26, with respect to one or more nozzles associated with a printhead, such as 38a.

In block 506, the method 500 ends. Other methods for providing maintenance for a printhead comprising one or more ink nozzles for dispensing ink or bidirectional printhead maintenance can include some or all of the above elements as well as other elements in accordance with the invention.

In this manner, the method 500 can provide a method for providing maintenance for a printhead comprising one or more ink nozzles for dispensing ink. The printhead wiper used with this method can include a relatively sharp or crisp edge on one side and an edge designed to wick ink out of the nozzles. A wiper utilizing this design can be implemented with a maintenance station as an alternative to a wet wipe. Moving the wiper in one direction, the relatively rounded edge can wick ink out of some or all of the nozzles onto the nozzle plate, in an attempt to re-wet dried ink to make it easier to remove. This would be followed by moving the wiper in another or opposing direction, where the relatively sharp or crisp edge can clean the nozzle plate.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method for performing maintenance on a printhead using a wiper having a first edge and a second edge, the printhead having one or more ink nozzles for dispensing ink, the method comprising:
during a printing operation, manipulating the first edge of the wiper in a first direction across some or all of the ink nozzles, wherein at least a portion of the nozzles are cleaned by the first edge; and
based at least in part on a maintenance-type command, manipulating the second edge of the wiper in a second direction, substantially opposite the first direction, across some or all of the ink nozzles, wherein at least a portion of the nozzles are cleaned by the second edge.

2. The method of claim 1, wherein the maintenance-type command is received from at least one of the following: a user, a printer, a server, a processor, a memory, a data storage device, a client-type device, or a remote location.

3. A method for performing maintenance on a printhead, using a wiper that includes a first edge and a second edge, the printhead having one or more ink nozzles for dispensing ink, the method comprising:
during a first time period, manipulating the first edge of the wiper in a first direction across some or all of the ink nozzles, wherein at least a portion of the nozzles are cleaned by the first edge; and
during a second time period, manipulating the second edge of the wiper in a second direction across some or all of the ink nozzles, wherein at least a portion of the nozzles are cleaned by the second edge.

4. The method of claim 3, further comprising:
in response to an installation of a new printhead, causing the wiper to automatically move in the first and second directions across some or all of the ink nozzles of the new printhead.

5. The method of claim 3, wherein the first time period is the time period associated with a half life of the printhead, a half life of a printer associated with the printhead, a half life of a component of the printhead, a half life of a component associated with the printer, an event associated with a printhead, an event associated with a printer, a number of pages printed, or a number of ink drops fired by the printhead.

6. The method of claim 3, wherein the first time period is a first half life for the printhead, and the second time period is a second half life.

7. The method of claim 3, wherein the first time period is a first half life for a printer associated with the printhead, and the second time period is a second half life for the printer.

8. The method of claim 3, wherein the first and second directions are substantially opposite directions.

9. The method of claim 8, wherein the second period begins immediately after the first period ends.

10. The method of claim 9, wherein maintenance is performed by the wiper moving the first edge across the nozzles during the first time period, and at the end of the first time period, in response to a command received from a printer, the second edge of the wiper is used to perform the maintenance and the wiper moves in the second direction for the duration of the second time period.

11. The method of claim 10, wherein the first time period is an anticipated half-life of the printhead, and the second time period begins at the end of the first time period and lasts until the printhead is replaced.

12. The method of claim 10, wherein the command received from the printer indicates that the first time period has ended and that future maintenance should be performed using the second edge of the wiper.

13. The method of claim 12, wherein the command is issued by firmware associated with the printer.

14. An apparatus for providing maintenance to a printhead comprising one or more ink nozzles for dispensing ink, the apparatus comprising:
at least one wiper comprising:
a first edge operable to wick ink from some or all of the ink nozzles when the first edge is manipulated in a first direction across some or all of the ink nozzles; and
a second edge operable to be manipulated in a second direction across some or all of the ink nozzles, wherein at least a portion of the nozzles are cleaned by the second edge; and
a drive mechanism associated with a printer, wherein the at least one wiper can mount to at least a portion of the drive mechanism, and the drive mechanism is operable to control the at least one wiper.

15. The apparatus of claim 14, wherein the first edge is a substantially rounded edge.

16. The apparatus of claim 15, wherein the first edge is configured to wick ink out of the nozzles and onto a nozzle plate as the first edge is manipulated in the first direction.

17. The apparatus of claim 16, wherein the second edge is configured to remove some or all of the ink deposited onto the nozzle plate as the second edge is manipulated in the second direction.

18. The apparatus of 15 wherein the first direction is substantially opposite the second direction.
